(19) United States
(12) Patent Application Publication
(10) Pub. No.: US 2005/0105213 A1
(43) Pub. Date: May 19, 2005

(54) Disk drive and magnetic head device for perpendicular magnetic recording

(75) Inventors: Akihiko Takeo, Kunitachi-shi (JP); Koji Yano, Ome-shi (JP); Kazuhito Shimomura, Akishima-shi (JP); Koji Osafune, Ome-shi (JP); Tsutomu Tanaka, Ome-shi (JP); Yoichiro Tanaka, Kawasaki-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/943,226

(22) Filed: Sep. 17, 2004

(30) Foreign Application Priority Data
Sep. 30, 2003 (JP) 2003-339977

(51) Int. Cl. G11B 5/127

(52) U.S. Cl. 360/125

(57) ABSTRACT

A disk drive including a write head for perpendicular magnetic recording is disclosed. The write head includes a main recording magnetic pole which applies a perpendicular recording magnetic field onto a disk medium and an auxiliary magnetic pole, and has a structure in which the auxiliary magnetic pole is arranged on a rear end side of the main recording magnetic pole through a small gap there between in a relative movement direction of this write head. this write head.

### CROSS-REFERENCE TO RELATED APPLICATIONS

This application is based upon and claims the benefit of priority from prior Japanese Patent Application No. 2003-339977, filed Sep. 30, 2003, the entire contents of which are incorporated herein by reference.

### BACKGROUND OF THE INVENTION

1. Field of the Invention

The present invention generally relates to a disk drive adopting a perpendicular magnetic recording mode, and more particularly to a write head which performs perpendicular magnetic recording.

2. Description of the Related Art

Generally, in a disk drive adopting a perpendicular magnetic recording mode, there is used a magnetic head having a write head comprising a single pole type head (SPT) suitable for perpendicular magnetic recording. This write head has a main magnetic pole (recording magnetic pole) which applies a recording magnetic field in a perpendicular direction of a disk medium and an auxiliary magnetic pole which is called a return yoke.

In the perpendicular magnetic recording type disk drive, an improvement concerning a structure of the write head is particularly pushed ahead in order to realize a higher recording density. As a concrete example, a write head structure in which a main magnetic pole is provided on a leading side away from a return yoke has been proposed (see, e.g., Jpn. Pat. Appln. KOKAI Publication No. 2001-101612).

This reference of the prior art discloses that a distribution of a magnetic field intensity emitted from a write head can be made sharp on a trailing side by this head structure.

In recent years, in the perpendicular magnetic recording type disk drive, there has been confirmed a phenomenon that an edge portion of a recording magnetization transition form which occurs on a disk medium due to perpendicular magnetic recording is curved or disordered by an influence of a skew angle or the like of a magnetic head. Particularly, in case of recording a servo burst pattern included in servo information required for a head positioning control (servo control), when this phenomenon occurs, there is produced a problem in which a curved portion is generated at an edge portion in a track widthwise direction of the servo burst pattern and the asymmetry is generated.

The servo information requires a high signal quality since it affects an accuracy of a head positioning operation. Therefore, when a percentage of the curved portion in the entire servo burst is increased due to the curvature of the magnetization transition form, the signal quality required as the servo information cannot be assured. In particular, with a reduction in intervals of servo tracks recorded on the disk medium owing to an impulsion for a higher track pitch, it is hard to ignore the influence of the curvature generated in the edge portion in the magnetization transition form, i.e., the edge portion in the track widthwise direction of a magnetization pattern.

### BRIEF SUMMARY OF THE INVENTION

In accordance with one embodiment of the present invention, there is provided a disk drive including a magnetic head for perpendicular magnetic recording.

The disk drive comprises a disk medium for perpendicular magnetic recording; and a magnetic head including a main recording magnetic pole which applies a perpendicular recording magnetic field onto the disk medium and an auxiliary magnetic pole, the auxiliary magnetic pole being arranged on a rear end side of the main recording magnetic pole in a relative traveling direction of the magnetic head, a length of the auxiliary magnetic pole in a track widthwise direction on the disk medium being larger than a length of the main recording magnetic pole.

### BRIEF DESCRIPTION OF THE SEVERAL VIEWS OF THE DRAWING

FIG. 1 is a view showing a structure of a magnetic head for perpendicular magnetic recording concerning an embodiment according to the present invention;

FIG. 2 is a view illustrating a structure of a write head concerning the embodiment;

FIG. 3 is a view showing a structure of a double-layered disk medium concerning the embodiment;

FIG. 4 is a view illustrating a structure of a servo track writer concerning the embodiment;

FIG. 5 is a view showing an external appearance of a perpendicular magnetic recording type disk drive concerning the embodiment;

FIG. 6 is a view showing an example of a magnetization pattern illustrating an effect of the embodiment;

FIG. 7 is a view showing an example of the magnetization pattern illustrating an effect of the embodiment;

FIG. 8 is a view showing an example of the magnetization pattern of servo information illustrating the effect of the embodiment;

FIGS. 9A and 9B are views showing a write head and a magnetization pattern of servo information concerning the embodiment;

FIG. 10 is a view illustrating a head positioning accuracy concerning the effect of the embodiment;

FIG. 11 is a view illustrating a structure of a write head concerning another embodiment;

FIG. 12 is a view illustrating recording magnetic field characteristics of the write head concerning another embodiment; and

FIG. 13 is a view illustrating a head positioning accuracy concerning the effect of another embodiment.

### DETAILED DESCRIPTION OF THE INVENTION

Embodiments according to the present invention will now be described hereinafter with reference to the accompanying drawings.

(Structure of Magnetic Head)

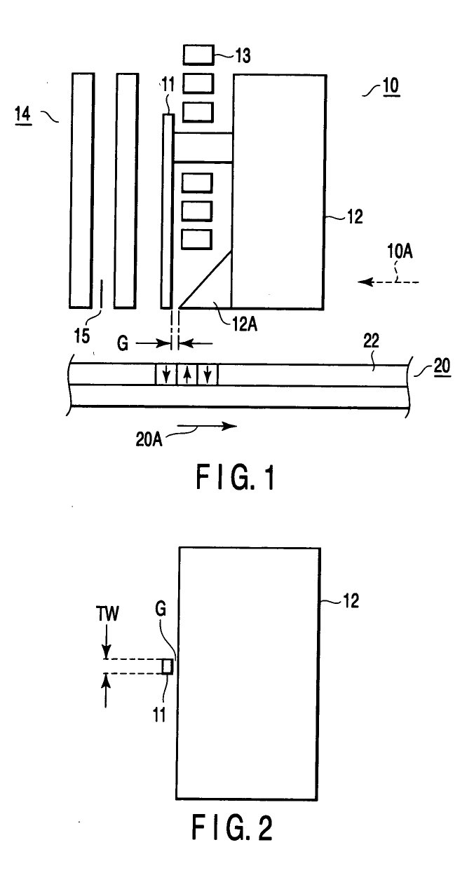

FIGS. 1 and 2 are views showing a structure of a magnetic head for perpendicular magnetic recording concerning this embodiment. FIG. 1 is a side cross-sectional view, and FIG. 2 is a plane cross-sectional view.

A magnetic head 10 has a write head and a read head 14 which are separated from which other, and is mounted on a non-illustrated slider. The read head 14 is usually a head which has a GMR (giant magnetoresistive) element 15 and is exclusively used for reading.

The write head is a single pole type head suitable for perpendicular magnetic recording, and has a recording magnetic head 11 as a main magnetic pole, a return yoke 12 as an auxiliary magnetic pole and an excitation coil 13.

The recording magnetic head 11 is formed of a soft magnetic material having a relatively high magnetic permeability, and excites a recording magnetic field according to a recording current caused to flow through the excitation coil 13. The recording magnetic pole 11 generates a strong recording magnetic field by narrowing down a track width with respect to an opposed surface (recording layer 22) of a disk medium 20.

The return yoke 12 is an auxiliary magnetic pole by which a perpendicular magnetic flux generated from the recording magnetic pole 11 passes through a soft magnetic layer of the later-described disk medium 20 and constitutes a closed magnetic path. In regard to concrete materials of the recording magnetic pole 11, the recording magnetic pole 11 is formed of a magnetic material such as a soft magnetic film which includes iron (Fe) and cobalt (Co) as main components and has a high maximum magnetic flux saturation density which is, e.g., not less than 2 tesla. As to a concrete material of the return yoke 12, the return yoke 12 is formed of a magnetic material such as Permalloy which includes nickel (Ni) and iron (Fe) as main components, has small magnetostrictions and is easy to be processed.

The write head according to this embodiment has a structure in which the return yoke 12 is arranged on a rear end side in a relative traveling direction (arrow 10A) of the magnetic head with respect to a traveling direction (arrow 20) of the disk medium 20. That is, the return yoke 12 is arranged on a trailing edge side of the magnetic head 10. Therefore, the recording magnetic pole 11 is provided on a leading edge side.

Further, in the write head according to this embodiment, the recording magnetic pole 11 and a part 12A of the return yoke 12 are oppositely arranged with a very narrow gap G therebetween on the side opposed to the disk medium 20.

As shown in FIG. 2, a track corresponding to a track width TW of the write head is constituted on the disk medium 20 by perpendicular magnetic recording using the recording magnetic pole 11. In a direction of this track width, a length of the return yoke 12 is formed to be very larger than a length of the recording magnetic pole 11.

(Disk Medium, Disk Drive and Servo Track Writer)

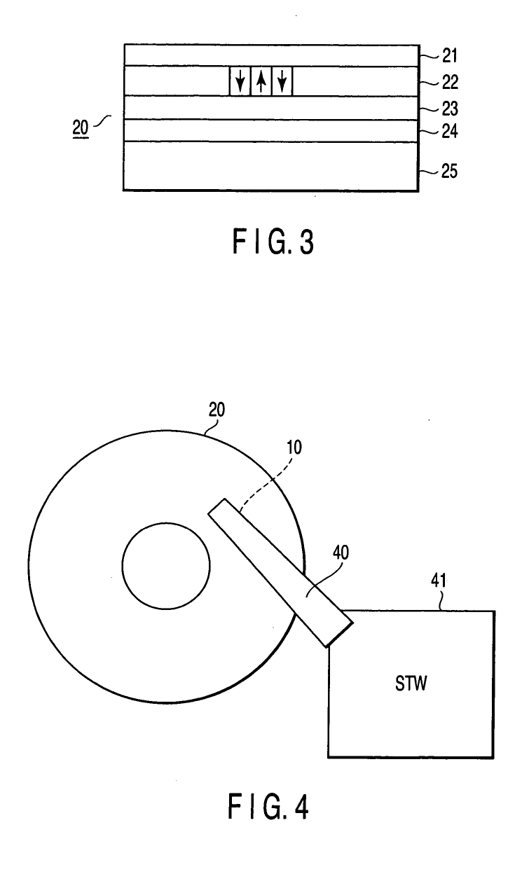

As shown in FIG. 3, the disk medium 20 is a double-layered perpendicular recording medium in which a perpendicular magnetic recording layer (which will be simply referred to as a recording layer) 22 and a soft magnetic layer 24 are superimposed on a substrate 25.

It is to be noted that an oriented layer 23 and a protection layer 21 are sequentially superimposed on the substrate 25. Furthermore, each layer comprises a film formed of a composition of a plurality of different materials. As described above, a perpendicular magnetic flux applied onto the recording layer 22 is diffused through the soft magnetic layer 24 and the return yoke 12, turned to a weak magnetic field and forms a closed magnetic path returning to the excitation coil 13.

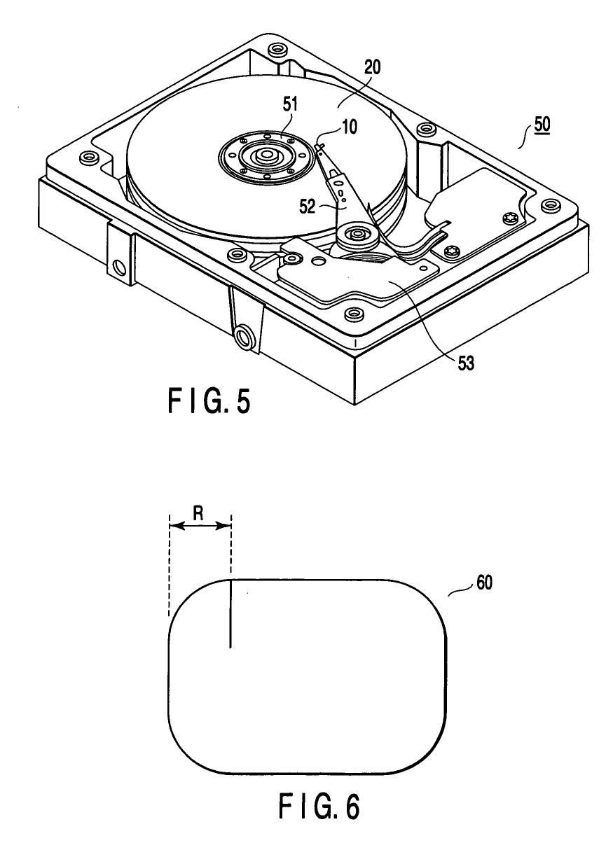

In the perpendicular magnetic recording type disk drive 50, as shown in FIG. 5, the disk medium 20 attached to a spindle motor 51 and the magnetic head 10 mounted on an actuator 52 are assembled in a case. The actuator 52 is a head positioning mechanism which moves the head 10 on the disk medium 20 in the radial direction thereof by a driving force of a voice coil motor 53.

Moreover, as a disk drive manufacturing step, there is a servo write step by which servo information is recorded on the disk medium 20 in advance. The servo write step uses a dedicated servo track writer (STW) 41 as shown in FIG. 4.

In this embodiment, the STW 41 has an actuator 40 having the magnetic head 10 for perpendicular magnetic recording mounted thereon. Therefore, the STW 41 records servo information on the disk medium 20 by perpendicular magnetic recording using such a write head as shown in FIG. 1. The servo information roughly comprise a cylinder code which is used to identify tracks, and a servo burst pattern which is used to position the head in each track. It is to be noted that the STW 41 may have a servo write performing mode which uses a magnetic head assembled in a disk drive 50 to be manufactured in addition to a mode having the magnetic head 10 as a servo write dedicated head.

(Operation of Perpendicular Magnetic Recording)

A description will now be given as to the perpendicular magnetic recording operation of the write head when the STW 41 is used to record servo information on the disk medium 20 by utilizing the magnetic head 10 incorporated in the disk drive 50.

In the disk drive, many tracks (data tracks) having concentric circular forms are constituted on the disk medium 20 in the radial direction thereof. In order to identify each of these tracks and position the head 10, there is a servo write step of previously recording servo information in the manufacturing process.

Generally, in the disk drive, there is adopted a sector servo mode that a recording area (data sector) for data and a recording area (servo sector) for servo information are divided into areas and a plurality of these two types of divided areas exist in one track. When a recording signal (servo information) for the servo sector is once recorded, it will not be erased by overwriting or the like.

In this embodiment, the STW 41 writes servo information (servo track signal) on the disk medium 20 by using the write head of the magnetic head 10 incorporated in the disk drive 50.

Here, FIG. 8 shows a magnetization pattern subjected to perpendicular magnetic recording on the disk medium 20 by a write head having a structure different from the write head according to this embodiment (which will be referred to as a head according to a comparative example hereinafter). In FIG. 8, reference characters A and B denote servo burst patterns.

The head according to the comparative example has a structure in which a recording magnetic pole 11 is arranged on a rear end side with respect to a head traveling direction 10A and a gap between the recording magnetic pole 11 and a return yoke 12 is large as compared with the write head according to this embodiment shown in FIG. 1. That is, the rear end side of the recording magnetic pole 11 of the head according to the comparative example is opened.

When a magnetization pattern 60 of the servo track signal is recorded by using such a head according to the comparative example, curvatures 80 caused due to recording blurs are generated in a track widthwise direction (TW) as shown in FIG. 8. FIG. 6 is a view showing this magnetization pattern 60 in an enlarged manner.

These curvatures are generated because an constant magnetic field contour distribution of a recording magnetic field from the head according to the comparative example is curved at an end portion of the head as spacing from the head is large when forming a magnetization transition on the disk medium.

Generally, in the servo track signal write operation, there is used a track width (TW) of the. write head which is sufficiently large with respect to the servo track interval. In the servo track signal write operation, there is adopted a method by which the write head is fed from the outermost circumference on the disk medium in a fixed direction, i.e., the innermost circumferential direction or its reverse direction while signals of the respective servo tracks are overwritten. FIG. 8 shows the magnetization patterns of the servo burst patterns A and B which are continuously recorded by the write head which is moved at fixed track intervals.

Here, although the recording magnetic field from the write head is evenly generated in the vicinity of the center of the tracks, the recording magnetic field becomes dull in the vicinity of the track ends and curvatures of the transition form are generated at the track ends as shown in FIG. 6 since the recording magnetic field three-dimensionally spreads. In FIG. 6, although just some of the entire tracks have the curved forms at the track ends, the curvatures remain on the side where no signal is overwritten because the servo signals are overwritten at narrower intervals than the recording track width of the head. Meanwhile, in FIG. 8, it can be understood that the curved portions account for a large percentage with respect to the entire signals.

In the small positioning control for positioning the magnetic head 10 at the center of the tracks, the magnetization patterns of the above-described servo burst patterns A and B are used. Specifically, as shown in FIG. 8, when a boundary portion between the servo burst patterns A and B is to be positioned as the center of the data tracks, the positioning control is carried out in such a manner that a signal amplitude from a track A and a signal amplitude from a track B become equal by traveling of the read head across the track A and the track B.

In this case, as shown in FIG. 8,. when the asymmetry is produced in the lateral direction from the boundary between the servo burst patterns A and B due to the curvatures 80 of the magnetization transition forms in the magnetization pattern 60, the read signal amplitude from the servo burst pattern B becomes smaller than the amplitude from the servo burst pattern A even if the read head exists on this boundary, and erroneous positional information is supplied.

Thus, in order to obtain the correct positional information from the servo bust patterns, the magnetization transition curvatures 80 generated at the end portions of the tracks must be suppressed to prevent the asymmetry from being generated between the servo burst patterns A and B. That is, in order to effect the highly accurate head positioning operation, a length of the magnetization transition curved portion R in the track widthwise direction in the magnetization pattern 60 must be reduced as much as possible as shown in FIG. 6.

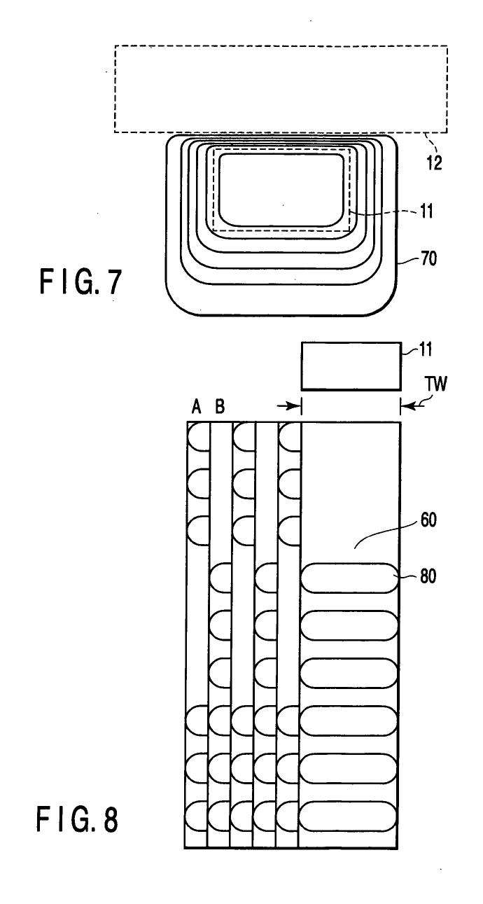

FIG. 7 shows that the recording magnetic field distribution 70 of the recording magnetic pole 11 of the write head (see FIG. 1) according to this embodiment is set and checked on the disk medium surface.

That is, the write head according to this embodiment has a structure in which the return yoke 12 is arranged as a shield member of the recording magnetic field produced by the recording magnetic pole 11 as shown in FIG. 7. The recording magnetic field varies from a maximum value of a positive magnetic field intensity to 0 or a negative magnetic field intensity in a short distance (gap G in FIG. 1) from the rear end of the recording magnetic pole 11 to the front end of the return yoke 12. Based on this, a sharp magnetic field inclination can be formed with respect to the front end side of the recording magnetic pole 11 without the return yoke 12 as the distance between the recording magnetic pole 11 and the return yoke 12 which functions as the shield member is short.

Therefore, since the magnetic field in the gap (G) between the recording magnetic pole 11 and the return yoke 12 becomes even in the track widthwise direction, a curving quantity of each track end portion can be suppressed on the side close to the return yoke 12 as the shield member.

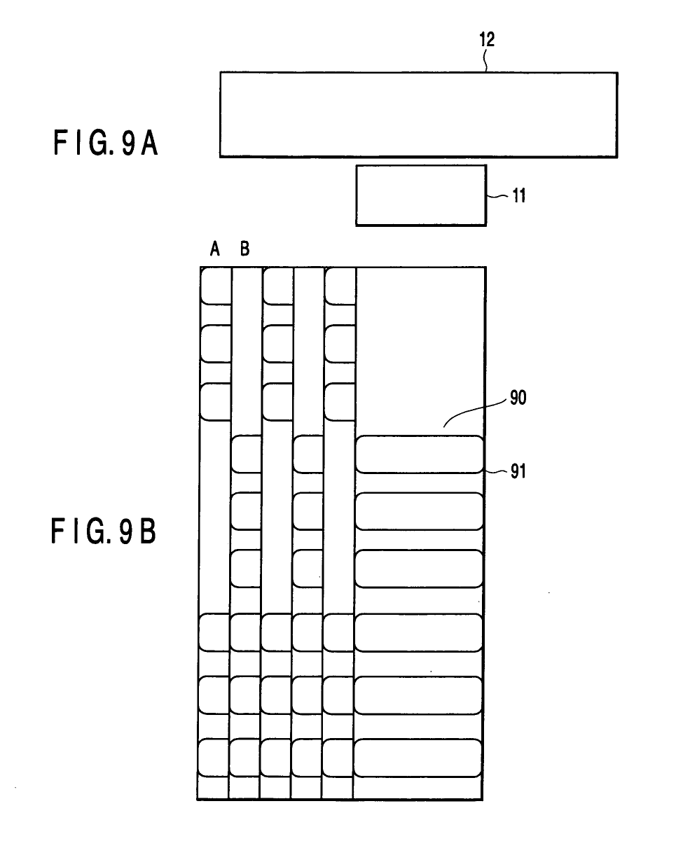

FIG. 9B shows a shape of a magnetization pattern 90 of the servo track signal recorded by the write head shown in FIG. 9A. As shown in FIG. 9, the magnetization pattern 90 is a pattern in which each magnetization transition curvature 91 in the track widthwise direction is reduced.

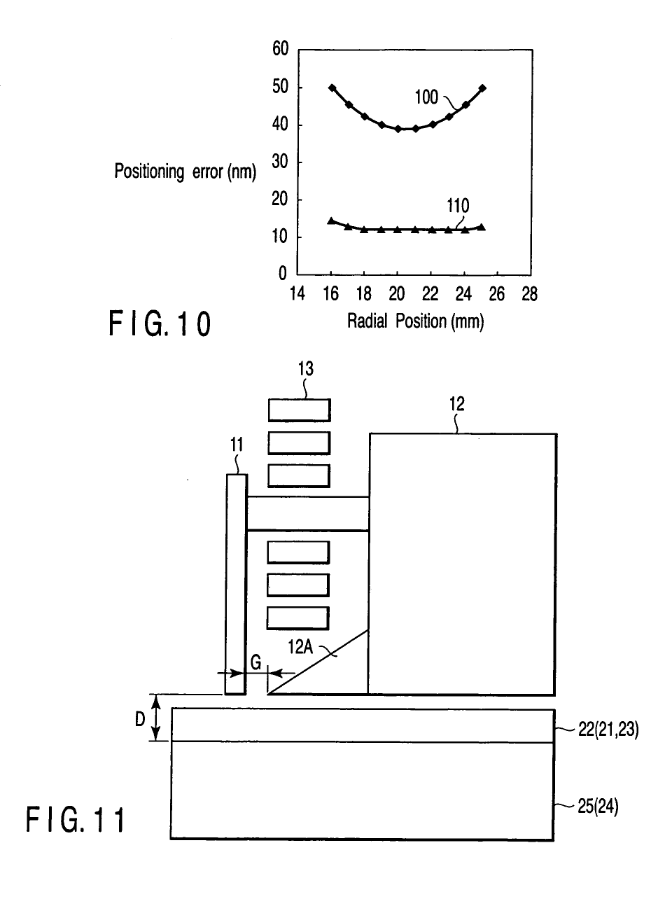

FIG. 10 shows a result of comparing the positioning accuracy (curved line 110) in the servo write operation using the write head according to this embodiment with the positioning accuracy (curved line 100) in the servo write operation using the head according to the comparative example.

That is, in FIG. 10, a horizontal axis represents each radial position of the tracks, and a vertical axis represents a positioning error quantity at each radial position. The curved line 110 shows positioning characteristics when the head positioning operation is executed by using servo information (servo burst pattern) recorded on the disk medium by the write head according to this embodiment. As apparent from FIG. 10, it can be understood that the positioning characteristics obtained when using the write head according to this embodiment have no positioning irregularities at each radial position and the positioning is stably carried out in all the tracks as compared with the head according to the comparative example.

As described above, to sum up, the write head according to this embodiment has a structure in which the return yoke 12 is arranged as the shield member with an internal of the small gap G from the rear end of the recording magnetic pole 11, as shown in FIG. 11. Therefore, in the magnetization transition generated on the disk medium due to perpendicular magnetic recording, the curvatures produced at the edge portions of the magnetization pattern can be reduced.

In particular, in case of recording servo information by perpendicular magnetic recording by using the write head according to this embodiment, since the curved portions of the servo burst pattern in the track widthwise direction can be suppressed, the servo information with the high signal quality can be assured. As a result, the head positioning accuracy in the perpendicular magnetic recording type disk drive can be greatly improved.

### OTHER EMBODIMENTS

FIG. 11 is a view illustrating a structure of a write head suitable for perpendicular magnetic recording concerning another embodiment. The write head according to this embodiment has basically the same structure as that shown in FIG. 1.

This embodiment concerns a structure of the write head which can accurately constitute servo tracks by recording servo information in the servo write step in particular.

In general, a magnetization transition shape of the disk medium is formed along a recording magnetic field contour having the same intensity as a coercive force of the disk medium. It is considered that the sufficiently excellent recording can be effected as long as a maximum recording magnetic field from the write head is approximately twofold of this coercive force.

Here, in the recording magnetic field distribution 70 shown in FIG. 7, the recording magnetic field distribution sharply varies from an opposed portion of the recording magnetic pole 11 from which the recording magnetic field having the substantially maximum magnetic field intensity is produced to an opposed portion of the return yoke at which 0 or the negative magnetic field intensity is obtained. At this time, since the recording magnetic field corresponding to the coercive force of the disk medium is substantially ½ of the maximum recording magnetic field intensity, it is distributed in the vicinity of the center of the gap between the recording magnetic pole 11 and the return yoke 12 (G in FIG. 11) shown in FIG. 7.

Assuming that each curvature in the magnetic field distribution at the end portion of the track on the disk medium is substantially circularly distributed from the end portion of the recording magnetic pole 11, a circular curvature whose diameter is “G/2” is generated, and its length R is approximately G/2. If a track width (TL) of the servo track is longer than the gap G between the recording magnetic pole 11hand the return yoke 12 of the head, a ratio of the curved portion in the servo track is ½ or below even at the maximum level.

Therefore, if the gap G corresponding to the distance between the recording magnetic pole 11 and the return yoke 12 is smaller than the servo track interval TL, the excellent track positioning operation can be provided without being adversely affected by the curved portion in the recorded servo track signal.

Moreover, this embodiment also takes the influence of recording blurs due to a distance (D) from the recording magnetic pole 11 to the soft magnetic layer 24 including the recording layer 22 of the disk medium 20 into consideration. As shown in FIG. 11, the distance from the end of the recording magnetic pole 11 to the soft magnetic layer 24 of the disk medium is defined as D.

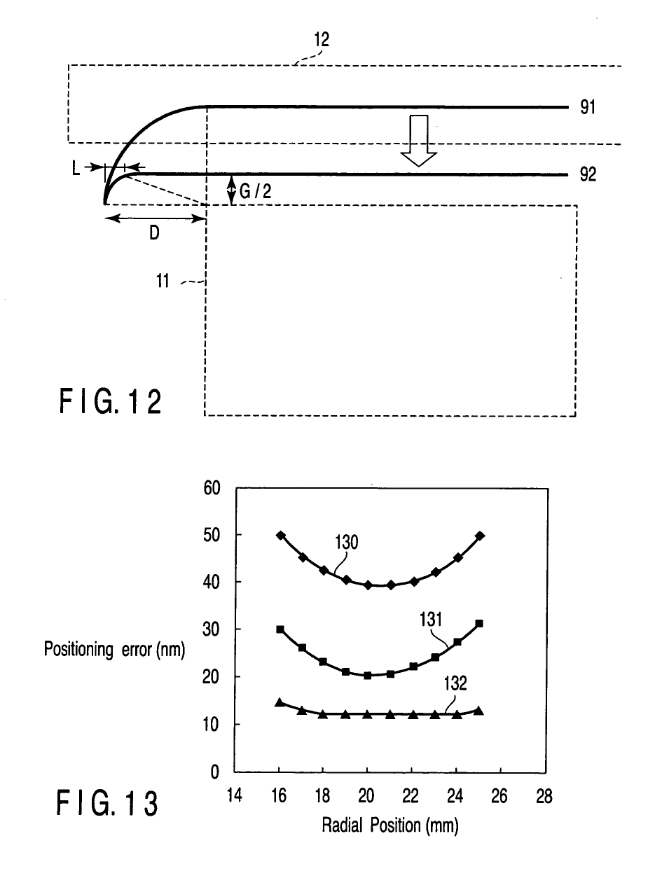

FIG. 12 shows a constant magnetic field contour of a recording magnetic field applied to the disk medium from the write head according to this embodiment. When a shield member corresponding to the return yoke 12 is not provided at the rear end portion of the recording magnetic pole 11, a curvature having a radius D is generated at the recording magnetic pole 11 under the worst conditions, and a constant magnetic field contour 91 is obtained.

On the other hand, in the write head according to this embodiment, since the shield member corresponding to the return yoke 12 is provided at the rear end of the recording magnetic pole 11, the magnetic field intensity directly below this shield member becomes 0 or it is substantially uniformized with a polarity reversed from that directly below the recording magnetic pole even though it is small. Therefore, the constant magnetic field contour 92 on the shield member side exists in the gap (G) between the recording magnetic pole 11 and the return yoke 12 as the shield member as shown in FIG. 12. At this time, the curvature generated at the end portion of the recording magnetic pole 11 becomes short and a phase shift caused due to the curvature can be eliminated on the inner side of the original constant magnetic field contour 91. In this case, a length L in the track widthwise direction of an area in which a phase lag caused due to the curvature at the end portion remains without being substantially eliminated becomes at least a length represented by the following expression (2).

$$L = D - \sqrt{{D}^{2} - \frac{{G}^{2}}{4}} \qquad ( 2 )$$

In order to prevent a waveform change due to a phase lag generated in this area from affecting the positioning, the condition represented by the following relational expression (3) must be satisfied.

$$0 < D - \sqrt{{D}^{2} - \frac{{G}^{2}}{4}} < \frac{TL}{2} \qquad ( 3 )$$

A description will now be given as to measurement examples of the influence given to the signal quality of the servo track signal in case of recording servo information on the disk medium by using the write head according to this embodiment. As measurement parameters, as shown in FIG. 11, there are set a gap G between the recording magnetic pole 11 and the return yoke 12 (shield member), and a distance (spacing) D from the end of the recording magnetic pole 11 and the soft magnetic layer 24 of the disk medium. Here, as the disk medium 20, there is used one having a thickness of the recording layer 22 being 20 nm, a thickness of the oriented layer 23 being 15 nm, a thickness of the protection layer 21 being 3 nm, and a distance from the medium surface to the soft magnetic layer 24 being 38 nm.

Here, if a flying quantity (flying height) between the end of the recording magnetic pole 11 and the medium surface is 12 nm, the spacing D is 50 nm.

FIG. 13 shows a result of incorporating in the disk drive the disk medium on which servo information is recorded by the STW 41 using each of the conventional head according to the comparative example and the write head according to this embodiment, and measuring the head positioning accuracy.

In FIG. 13, a measurement result 130 corresponds to a case in which the head according to the comparative example, i.e., the conventional single pole type head (G cannot be defined and is infinitely great) is used, and the spacing D is 50 nm whilst the servo track pitch TL is 0.1 μm as the measurement parameters.

A measurement result 131 corresponds to a case in which the write head according to this embodiment is used, and the gap G is 300 nm, the spacing D is 55 nm and the servo track pitch TL is 0.09 μm as the measurement parameters.

A measurement result 132 corresponds to a case in which the write head according to this embodiment is used, and the gap G is 70 nm, the spacing D is 50 nm and the servo track pitch TL is 0.09 μm as the measurement parameters.

In FIG. 13, the measurement results 130 and 131 show that the servo information with the deteriorated signal quality is recorded and the head positioning accuracy is degraded. In particular, on the inner peripheral side or the outer peripheral side, the head positioning accuracy is lowered as a skew angle of the head becomes large.

On the other hand, the measurement result 132 shows that the servo information with the high quality is recorded on the disk medium, and the high head positioning accuracy is assured in the substantially entire range in the radial direction. That is, as can be understood from the measurement result 132, perpendicular magnetic recording of the servo information with the high quality can be realized by using the write head shown in FIG. 11 and setting the condition that the gap G is narrower than the servo track pitch TL as the measurement parameters or satisfying the condition shown in the Expression (3) with a relationship between the respective parameters including the spacing D.

It is to be noted that, as the following measurement example (which will be referred to as d for the convenience's sake) the high positioning accuracy that a positioning error at all the radial positions on the disk medium becomes not more than 15 nm can be assured when the write head according to this embodiment is used, and the gap G is 70 nm, the spacing D is 55 nm and the servo track pitch TL is 0.09 μm as the measurement parameters.

As a similar measurement example (which will be referred to as h for the convenience's sake), when-the write head according to this embodiment is used and the gap G is 100 nm, the spacing D is 50 nm and the servo track pitch TL is 0.13 μm as the measurement parameters, the high positioning accuracy that the positioning error at all the radial positions on the disk medium becomes not more than 15 nm can be likewise assured.

On the contrary, in the following respective measurement examples (which will be referred to as e, f and g for the convenience's sake), the worst value of the positioning error value at each radial position results in a value exceeding 15 nm, and the sufficient positioning accuracy cannot be obtained.

Specifically, each measurement example corresponds to a case in which the write head according to this embodiment is used, the spacing D is 50 nm and the servo track pitch TL is 0.09 μm as the measurement parameters. The measurement example (e) corresponds to a case in which the gap G is 100 nm as the measurement parameter other than those mentioned above. The measurement example (f) corresponds to a case in which the gap G is 120 nm as the measurement parameter other than those mentioned above. The measurement example (g) corresponds to a case in which the gap G is 140 nm as the measurement parameter other than those mentioned above.

As described above, to sum up, in the perpendicular magnetic recording type disk drive, as the write head of the STW 41 used in the servo write step, it is desirable for the rear end of such a recording magnetic pole 11 as shown in FIG. 11 to have a structure suitable for perpendicular magnetic recording in which the return yoke 12 having the small gap G is arranged as the shield member. Additionally, perpendicular magnetic recording of the servo information with the high quality can be realized by-setting the condition that the gap G is narrower than the servo track pitch TL as a condition when recording the servo information, or by satisfying the condition shown in the Expression (3) with the relationship between the respective parameters including the spacing D.

It is to be noted that the description has been given as to the examples in which the servo information is recorded by using the dedicated servo recording device as the STW 41 in connection with this embodiment, but the present invention is not restricted thereto, and the highly accurate data recording can be also realized in the recording operation for user data in the disk drive. Specifically, there are advantages, e.g., facilitating an improvement in accuracy with almost no shifting of an azimuth angle between the servo track signal and the read head or the influence of eccentricity.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. A disk drive comprising:
a disk medium for perpendicular magnetic recording; and
a magnetic head including a main recording magnetic pole which applies a perpendicular recording magnetic field onto the disk medium and an auxiliary magnetic pole, the auxiliary magnetic pole being arranged on a rear end side of the main recording magnetic pole in a relative traveling direction of the magnetic head, a length of the auxiliary magnetic pole in a track widthwise direction on the disk medium being larger than a length of the main recording magnetic pole.

2. The disk drive according to claim 1, wherein the auxiliary magnetic pole is formed of a magnetic material having a low magnetic flux saturation density with respect to the main recording magnetic pole.

3. The disk drive according to claim 1, wherein the auxiliary magnetic pole has a small gap from a rear end of the main recording magnetic pole, and is arranged as a shield member which shields a recording magnetic field of the main recording magnetic pole.

4. The disk drive according to claim 1, wherein the small gap between the main recording magnetic pole and the auxiliary magnetic pole is smaller than an interval of tracks recorded on the disk medium in accordance with a recording magnetic field from the main recording magnetic pole.

5. A magnetic head device comprising:
a main recording magnetic pole which applies a perpendicular recording magnetic field onto the disk medium for perpendicular magnetic recording, and an auxiliary magnetic pole,
the auxiliary magnetic pole being arranged on a rear end side of the main recording magnetic pole in a relative movement direction of the magnetic head, a length of the auxiliary magnetic pole in a track widthwise direction on the disk medium being larger than a length of the main recording magnetic pole.

6. The magnetic head device according to claim 5, wherein the auxiliary magnetic pole is formed of a magnetic material having a low magnetic flux saturation density with respect to the main recording magnetic pole.

7. The magnetic head device according to claim 5, wherein the auxiliary magnetic pole has a small gap from a rear end of the main recording magnetic pole, and is arranged as a shield member which shields a recording magnetic field of the main recording magnetic pole.

8. A servo writing apparatus comprising:
a unit which outputs servo information to be recorded on a disk medium for perpendicular magnetic recording; and
a magnetic head including a main recording magnetic pole which applies a perpendicular recording magnetic field onto the disk medium and an auxiliary magnetic pole, the auxiliary magnetic pole being arranged on a rear end side of the main recording magnetic pole in a relative movement direction of the magnetic head, a length of the auxiliary magnetic pole in a track widthwise direction on the disk medium being larger than a length of the main recording magnetic pole.

9. The servo writing apparatus according to claim 8, wherein the auxiliary magnetic pole is formed of a magnetic material having a low magnetic flux saturation density with respect to the main recording magnetic pole.

10. The servo writing apparatus according to claim 8, wherein the auxiliary magnetic pole has a small gap from a rear end of the main recording magnetic pole, and is arranged as a shield member which shields a recording magnetic field of the main recording magnetic pole.

11. The servo writing apparatus according to claim 8, wherein the small gap between the main recording magnetic pole and the auxiliary magnetic pole is smaller than an interval of tracks recorded on the disk medium in accordance with a recording magnetic field from the main recording magnetic pole.

12. The servo writing apparatus according to claim 8, wherein a relationship represented by the following expression (1) is satisfied:
$$0 < D - \sqrt{{D}^{2} - \frac{{G}^{2}}{4}} < \frac{TL}{2} \qquad ( 1 )$$
where G is the small gap between the main recording magnetic pole and the auxiliary magnetic pole, D is a spacing from an end of the main recording magnetic pole to a soft magnetic layer of the disk medium, and TL is an interval of servo tracks to be recorded on the disk medium.
